(19) United States
(12) Patent Application Publication
(10) Pub. No.: US 2017/0328011 A1
(43) Pub. Date: Nov. 16, 2017

(54) MULTI-PLY TISSUE CONTAINING LAMINATED AND NON-LAMINATED EMBOSSED AREAS

(71) Applicant: FIRST QUALITY TISSUE, LLC, Great Neck, NY (US)

(72) Inventors: James E. Sealey, II, Belton, SC (US); Byrd Tyler Miller, IV, Easley, SC (US); Justin S. Pence, Anderson, SC (US); Chris B. Anklam, Anderson, SC (US)

(21) Appl. No.: 15/595,673

(22) Filed: May 15, 2017

Related U.S. Application Data
(60) Provisional application No. 62/336,212, filed on May 13, 2016.

(51) Int. Cl. D21H 27/40; D21H 17/37; B31F 1/07; D21H 27/00

(52) U.S. Cl. CPC D21H 27/40; D21H 27/002; D21H 17/37; B31F 1/07; B31F 2201/0733; B31F 2201/0787

(57) ABSTRACT

The present invention is directed to structured tissue, and in particular to a structured, multilayer tissue with embossed areas that are laminated and embossed areas that are not laminated. The embossed areas that are laminated allow the plies to hold together during use to provide utility, while the non-laminated embossed areas have higher flexibility, lower strength, and improved softness due to disruption of fiber to fiber bonding imparted during the embossing process. Use of embossments of varying depths allows adhesive to be transferred from an adhesive applicator roll to a web in contact with the patterned emboss roll only at the crests of the embossments of the highest depth before multiple plies are laminated together using a nested embossing lamination process.

### RELATED APPLICATIONS

This application claims priority to U.S. Provisional Patent Application No. 62/336,212, filed May 13, 2016 and entitled MULTI-PLY TISSUE CONTAINING LAMINATED AND NON-LAMINATED EMBOSSED AREAS and is related to: U.S. patent application Ser. No. 13/837,685, filed Mar. 15, 2013, issued as U.S. Pat. No. 8,968,517; U.S. patent application Ser. No. 14/534,631, filed Nov. 6, 2014; U.S. patent application Ser. No. 14/951,121, filed Nov. 24, 2015; and U.S. Provisional Patent Application 62/328,350, filed Apr. 27, 2016, and the contents of these applications are incorporated herein by reference in their entirety.

### FIELD OF THE INVENTION

The present invention is directed to tissue, and in particular to a multilayer tissue with embossed areas that are laminated and embossed areas that are not laminated.

### BACKGROUND

Tissue webs can be produced using both water or air-laid technologies. The water-laid technologies of conventional dry and wet crepe are the predominant methods to make these webs. These methods comprise forming a nascent web in a forming structure, transferring the web to a dewatering felt where it is pressed to remove moisture, and adhering the web to a Yankee dryer. The web is then dried and creped from the Yankee dryer and reeled. When creped at a solids content of less than 90%, the process is referred to as conventional wet crepe (CWC). When creped at a solids content of greater than 90%, the process is referred to as conventional dry crepe (CDC). These processes can be further understood by reviewing Yankee Dryer and Drying, A TAPPI PRESS Anthology, pg 215-219. These methods are well understood and easy to operate at high speeds and production rates. Energy consumption per ton is low since nearly half of the water removed from the web is through drainage and mechanical pressing. Unfortunately, the web pressing also compacts the web which lowers web thickness and resulting softness.

Through Air Drying (TAD) and Uncreped Through Air Drying (UCTAD) processes are Wet-Laid technologies that avoid compaction of the web during drying and thereby produce webs of superior thickness and softness when compared to structures of similar basis weight and material inputs that are produced using the CWP or CDC process. The following U.S. patents describe creped through air dried products: U.S. Pat. Nos. 3,994,771, 4,102,737, 4,191,609, 4,529,480, 467,859, and 5,510,002, while U.S. Pat. No. 5,607,551 describes an uncreped through air dried product.

Other wet-laid processes, including those termed ATMOS, ETAD, and NTT, can also be utilized to produce tissue webs. Each of these processes/methods utilizes some pressing to dewater the web, or a portion of the web, which can reduce thickness and, as a result, softness. The ATMOS process and products are documented in U.S. Pat. Nos. 7,744,726, 6,821,391, 7,387,706, 7,351,307, 7,951,269, 8,118,979, 8,440,055, 7,951,269 or 8,118,979, 8,440,055, 8,196,314, 8,402,673, 8,435,384, 8,544,184, 8,382,956, 8,580,083, 7,476,293, 7,510,631, 7,686,923, 7,931,781, 8,075,739, and 8,092,652, 8,303,773, 7,905,989, 7,582,187, 7,691,230. The ETAD process and products are disclosed in U.S. Pat. Nos. 7,339,378, 7,442,278, and 7,494,563. The NTT process and products are disclosed in international patent application publication No. WO 2009/061079 A1.

Tissue webs are also made using the air-laid process. This process spreads the cellulosic, or other natural or synthetic fibers, in an air stream that is directed onto a moving belt. These fibers collect together to form a web that can be thermally bonded or spray bonded with resin and cured. Compared to wet-laid, the web is thicker, softer, more absorbent and also stronger. It is known for having a textile-like surface and drape. Spun-laid is a variation of the air-laid process, which produces the web in one continuous process where plastic fibers (polyester or polypropylene) are spun (melted, extruded, and blown) and then directly spread into a web. This technique has gained popularity as it can generate faster belt speeds and reduce costs.

In the constant effort to improve thickness and softness, multiple plies of a tissue web can be laminated together. There are many methods used to join or laminate multiple plies of tissue webs to produce a multi-ply tissue laminate. One method commonly used is embossing. Embossing is typically performed by one of three processes: tip to tip, nested, and/or rubber to steel embossing. Tip to tip embossing comprises axially parallel jumbo rolls of the tissue webs juxtaposed to form a nip between the crests of the embossing tips of the opposing emboss rolls. The nip in nested embossing has the embossing tips on one emboss roll meshed between the embossing tips of the other. Rubber to steel embossing comprises a steel roll with embossing tips opposed to a roll having an elastomeric roll cover wherein the two rolls are axially parallel and juxtaposed to form a nip where the embossing tips of the emboss roll mesh with the elastomeric roll cover of the opposing roll.

For example, during the tip to tip embossing process of a two ply tissue, each web is fed through separate nips formed between separate embossing rolls and pressure rolls with the embossing tips on the embossing rolls producing compressed regions in each web. The two webs are then fed through a common nip formed between the embossing rolls where the embossing tips on the two rolls bring the webs together in a face to face contacting relationship.

By comparison, nested embossing works by having the crests of the embossing tips on one embossing roll intermesh with the embossing tips on the opposing embossing roll. As the web is passed between the two embossing rolls, a pattern is produced on the surface of the web by the interconnectivity of the tips of one roll with the open spaces of the opposing roll.

Rubber to steel embossing works by having one hard embossing roll having embossing tips in a desired pattern and a back-side soft impression roll, often having an elastomeric roll cover aligned in an axially parallel configuration to form a nip between the rolls. As the web is passed through the nip between the rolls, the embossing tips impress the web against and into the rubber to deform the structure of the web.

It is possible to marry two or more webs of a tissue web (or different cellulosic structures) together using an adhesive. In an exemplary nested embossing process an adhesive applicator roll may be aligned in an axially parallel arrangement with one of the two embossing rolls forming a nip therewith, such that the adhesive applicator roll is upstream of the nip formed between the two embossing rolls. The adhesive applicator roll transfers adhesive to the embossed webs on the embossing roll at the crests of the embossing knobs. The crests of the embossing knobs typically do not touch the perimeter of the opposing roll at the nip formed therebetween necessitating the addition of a marrying roll to apply pressure for lamination. The marrying roll forms a nip with the same embossing roll, forming the nip with the adhesive applicator roll, downstream of the nip formed between the two embossing rolls. An example of this lamination method is described in U.S. Pat. No. 5,858,554.

Other attempts to laminate tissue webs include bonding the plies at junction lines wherein the lines include individual pressure spot bonds. The spot bonds are formed by the use of thermoplastic low viscosity liquid such as melted wax, paraffin, and hot melt adhesive, as described in U.S. Pat. No. 4,770,920. Another method laminates tissue webs by thermally bonding the webs together using polypropylene melt blown fibers, as described in U.S. Pat. No. 4,885,202. Other methods use metlblown adhesive applied to one face of an absorbent structure web in spiral patterns, stripe patterns, or random patterns before pressing the web against the face of a second absorbent structure, as described in U.S. Pat. Nos. 3,911,173, 4,098,632, 4,949,688, 4,891249, 4,996,091 and 5,143,776.

The above-described processes for laminating tissue webs result in tissue products with relatively low softness due in part to the loss of flexibility caused by the embossments.

### SUMMARY OF THE INVENTION

An object of the present invention is to provide a manufacturing method to produce tissue with improved softness.

According to an exemplary embodiment of the present invention, an emboss roll with varying depths of embossments is used in the nested configuration to marry two or more webs of a tissue web (or different cellulosic structures) together using an adhesive. An adhesive applicator roll is aligned in an axially parallel arrangement with one of the two embossing rolls forming a nip therewith, such that the adhesive applicator roll is upstream of the nip formed between the two embossing rolls. The adhesive applicator roll transfers adhesive to only the embossments of the highest depth at the crests of the embossing knobs. The crests of the embossing knobs typically do not touch the perimeter of the opposing roll at the nip formed therebetween, necessitating the addition of a marrying roll to apply pressure for lamination. The marrying roll forms a nip with the same embossing roll forming the nip with the adhesive applicator roll, downstream of the nip formed between the two embossing rolls. The resulting tissue laminate has embossed areas that are laminated together with the adhesive and embossed areas that are not laminated together due to the absence of adhesive. The laminated embossed areas provide strength and utility to the laminate when in use, while the embossed areas that are not laminated have reduced strength and thus provide the laminate with improved flexibility and softness.

A structured, multi-layer tissue according to an exemplary embodiment of the present invention comprises a first ply and a second ply, at least the first ply comprising first embossed areas and second embossed areas, the first embossed areas being laminated with the second ply and the second embossed areas not being laminated with the second ply.

According to at least one exemplary embodiment, the first embossed areas are laminated by adhesive.

According to at least one exemplary embodiment, the second embossed areas are devoid of adhesive.

According to at least one exemplary embodiment, the tissue has a softness of at least 90 HF.

According to at least one exemplary embodiment, the tissue has a TS7 less than 10.

According to at least one exemplary embodiment, the tissue has a CD stretch of at least 9.0%.

According to at least one exemplary embodiment, the tissue has a ball burst of less than 270 grams force.

According to at least one exemplary embodiment, the tissue is a through air dried tissue.

According to at least one exemplary embodiment, the tissue is made by an NTT process.

According to at least one exemplary embodiment, the second ply comprises first embossed areas and second embossed areas, the first embossed areas of the second ply are laminated with the first embossed areas of the first ply and the second embossed areas of the second ply are not laminated with the second embossed areas of the first ply.

A through-air-dried, multi-layer tissue according to an exemplary embodiment of the present invention comprises a first ply and a second ply, at least the first ply comprising first embossed areas and second embossed areas, the first embossed areas being laminated with the second ply and the second embossed areas not being laminated with the second ply.

A method of forming a structured, multilayer tissue according to an exemplary embodiment of the present invention comprises: providing at least two plies of tissue web; embossing at least one of the two plies using an embossment roll, the embossment roll comprising a pattern made up of first embossments of a first depth and second embossments of a second depth, the first depth being greater than the second depth, so that the at least one of the two plies comprises first embossed areas formed by the first embossments and second embossed areas formed by the second embossments; applying adhesive to the embossed at least one of the two plies using an applicator roll so that the first embossed areas are coated with adhesive and the second embossed areas are left devoid of adhesive; and laminating the at least two plies using the adhesive so that the at least one ply is laminated to the other ply only at the first embossed areas.

According to at least one exemplary embodiment, the method further comprises separately embossing the other ply.

According to at least one exemplary embodiment, the two plies are formed by a through-air-dried process.

According to at least one exemplary embodiment, the method results in a loss of machine direction tensile strength by an amount greater than 7% as compared to a multilayer tissue with all embossed areas laminated.

According to at least one exemplary embodiment, the method results in a loss of machine direction tensile strength by an amount greater than 10% as compared to a multilayer tissue with all embossed areas laminated.

According to at least one exemplary embodiment, the method results in a loss of machine direction tensile strength by an amount greater than 15% as compared to a multilayer tissue with all embossed areas laminated.

A structured, multi-layer tissue according to an exemplary embodiment of the present invention comprises a first ply and a second ply, at least the first ply comprising first embossed areas and second embossed areas, the first embossed areas being laminated with the second ply and the second embossed areas not being laminated with the second ply, the structured, multi-layer tissue having a TS7 less than 10 and a ball burst of greater than 200 grams force.

### BRIEF DESCRIPTION OF THE DRAWINGS

Exemplary embodiments of the present invention will be described with reference to the accompanying figures, wherein:

FIG. 1A is a diagram of an embossment pattern according to an exemplary embodiment of the present invention;

FIG. 1B is a cross sectional view of embossing knobs of an embossment roll according to an exemplary embodiment of the present invention;

FIG. 2A is a diagram of an embossment pattern according to an exemplary embodiment of the present invention;

FIG. 2B is a cross sectional view of embossing knobs of an embossment roll according to an exemplary embodiment of the present invention; and

FIG. 3 is a block diagram of a system for manufacturing a multi-ply tissue laminate according to an exemplary embodiment of the present invention.

### DETAILED DESCRIPTION

The present invention is directed to a laminate, and method of producing the laminate, composed of two or more webs/plies of a tissue web laminated together in a face-to face relationship using an aqueous adhesive so as to achieve a tissue product with enhanced softness. Each ply may have a plurality of embossments protruding outwardly from the plane of the ply towards the adjacent ply. The adjacent ply likewise may have opposing protuberances protruding towards the first ply. In the case of a three ply product, the central ply may have embossments extending outwardly in both directions.

The laminate can be manufactured by any wet-laid or air-laid methods, such as those described herein. The laminate is preferably a “structured tissue” which, for the purposes of the present disclosure, may refer to any tissue product having a pattern formed therein by a structuring fabric during a papermaking process, such as, for example, TAD, UCTAD, ATMOS, NTT, or ETAD papermaking processes. The materials used to produce the tissue web can be any fibers in any ratio selected from cellulosic based fibers such as wood pulps (softwood gymnosperms or hardwood angiosperms), Cannabis, cotton, regenerated or spun cellulose, jute, flax, ramie, bagasse, kenaf, or other plant based cellulosic fiber sources. Synthetic fibers can also be utilized such as polyolefin, polyester, or polypropylene.

The adhesives used to laminate the plies of absorbent structure can be water soluble. Suitable adhesives include, for example, polyvinyl alcohol, polyvinyl acetate, starch based or mixtures thereof. In an exemplary embodiment, the adhesive is provided in a mixture, with the adhesive making up 1% to 10% by weight of the mixture. Additionally; the mixture can contain up to 10% by weight of a water soluble cationic resin. Examples of suitable water soluble cationic resins include polyamide-epichlorohydrin resins, glyoxalated polyacrylamide resins, polyethyleneimine resins, polyethylenimine resins, or mixtures thereof. The remainder of the mixture is composed of water. This mixture is heated and maintained to a temperature between 90° F. to 150° F., preferably to 120° F.

The adhesive is heated and maintained at temperature utilizing an insulated stainless steel tank with heating elements uniformly distributed throughout the interior heating surface. The large amount of surface area heated provides uniform heating controlled by an adjustable thermostat. The tank includes an agitator to ensure proper mixing and heat transfer.

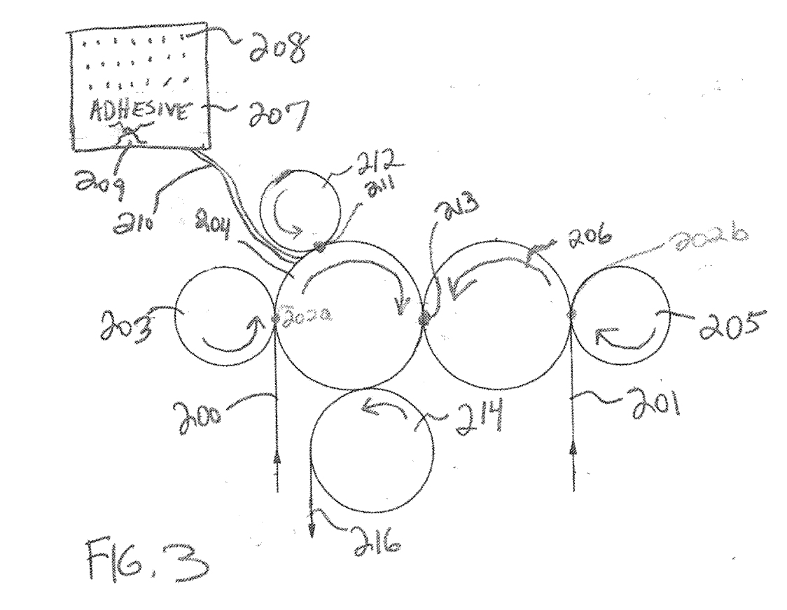

FIG. 3 shows an apparatus for manufacturing a laminate of two plies of a tissue web that are joined to each other, in a face-to-face relationship, in accordance with an exemplary embodiment of the present invention to form an absorbent product, such as a multi-ply tissue. As shown, two webs 200, 201 of single ply tissue, which may be manufactured, for example, according to any of the methods described above, are fed to respective pairs of mated pressure rolls 203, 205 and substantially axially parallel embossing rolls 204, 206. A first web 200 is thus fed through a nip 202a formed by pressure roll 203 and embossing roll 204 (also known as a pattern roll) and a second web 201 is likewise fed through a nip 202b between pressure roll 205 and embossing roll 206. The embossing rolls 204, 206, which rotate in the illustrated directions, impress an embossment pattern onto the webs as they pass through nip 202a and 202b. After being embossed, each ply may have a plurality of embossments protruding outwardly from the plane of the ply towards the adjacent ply. The adjacent ply likewise may have opposing protuberances protruding towards the first ply. If a three ply product is produced by adding a third pair of mated pressure and embossing rolls, the central ply may have embossments extending outwardly in both directions.

To perform the embossments at nips 202a and 202b, the embossing rolls 204, 206 have embossing tips or embossing knobs that extend radially outward from the rolls to make the embossments. In the illustrated embodiment, embossing is performed by nested embossing in which the crests of the embossing knobs on one embossing roll intermesh with the embossing knobs on the opposing embossing roll and a nip 213 is formed between the embossing rolls. As the webs 200, 201 are fed through nips 202a and 202b, a pattern is produced on the surface of the webs by the interconnectivity of the knobs on an embossing roll with the open spaces of the respective pressure roll.

An adhesive applicator roll 212 is positioned upstream of the nip 213 formed between the two embossing rolls and is aligned in an axially parallel arrangement with one of the two embossing rolls to form a nip therewith. The heated adhesive is fed from an adhesive tank 207 via a conduit 210 to applicator roll 212. The applicator roll 212 transfers heated adhesive to an interior side of embossed ply 200 to adhere the at least two plies 200, 201 together, wherein the interior side is the side of ply 200 that comes into a face-to-face relationship with ply 201 for lamination. The adhesive is applied to the ply at the crests of the embossing knobs 205 on embossing roll 204.

Notably, in the present invention, the adhesive is heated and maintained at a desired temperature utilizing, in embodiments, an adhesive tank 207, which is an insulated stainless steel tank that may have heating elements 208 that are substantially uniformly distributed throughout the interior heating surface. In this manner, a large amount of surface area may be heated relatively uniformly. Generally, an adjustable thermostat may be used to control the temperature of the adhesive tank 207. It has been found advantageous to maintain the temperature of the adhesive at between approximately 32 degrees C. (90 degrees F.) to 66 degrees C. (150 degrees F.), and preferably to around 49 degrees C. (120 degrees F.). In addition, in embodiments, the tank has an agitator 209 to ensure proper mixing and heat transfer.

The webs are then fed through the nip 213 where the embossing patterns on each embossing roll 204, 206 mesh with one another.

In nested embossing, the crests of the embossing knobs typically do not touch the perimeter of the opposing roll at the nip formed therebetween. Therefore, after the application of the embossments and the adhesive, a marrying roll 214 is used to apply pressure for lamination. The marrying roll 214 forms a nip with the same embossing roll 204 that forms the nip with the adhesive applicator roll 212, downstream of the nip formed between the two embossing rolls 204, 206.

In an exemplary embodiment, the embossing pattern has embossments of at least two different depths. The embossments with the most depth contacts the applicator roll and thus have adhesive transferred to the interior side of the embossed ply at the crests of the embossing knobs. The embossments with less depth will not contact the applicator roll and thus will not have adhesive transferred to the ply at these points. As a result, these embossments will not be laminated to the adjacent tissue ply. The difference in depth is preferably a minimum of 0.001 inch between the embossments with the most depth and the least depth to prevent the lower depth embossments from contacting the applicator roll. The maximum difference between the embossments with the most depth and the least depth is preferably below 0.150 inch such that the web in contact with the emboss roll contacts the lower depth embossments where it can disrupt fiber to fiber bonding to improve web flexibility and decrease web tensile strength. The preferred difference in depth between the high depth and low depth embossments is between 0.020 to 0.030 inch.

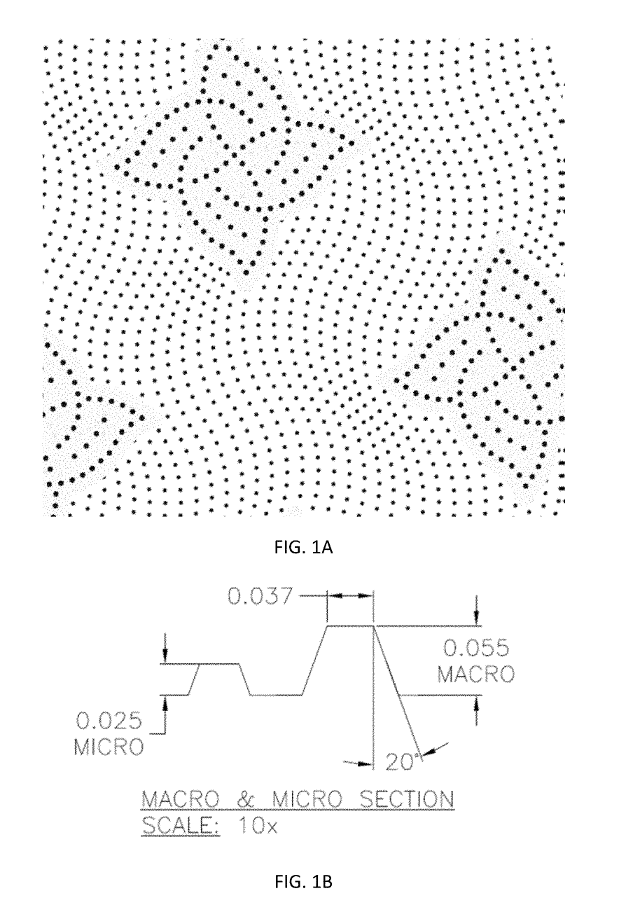

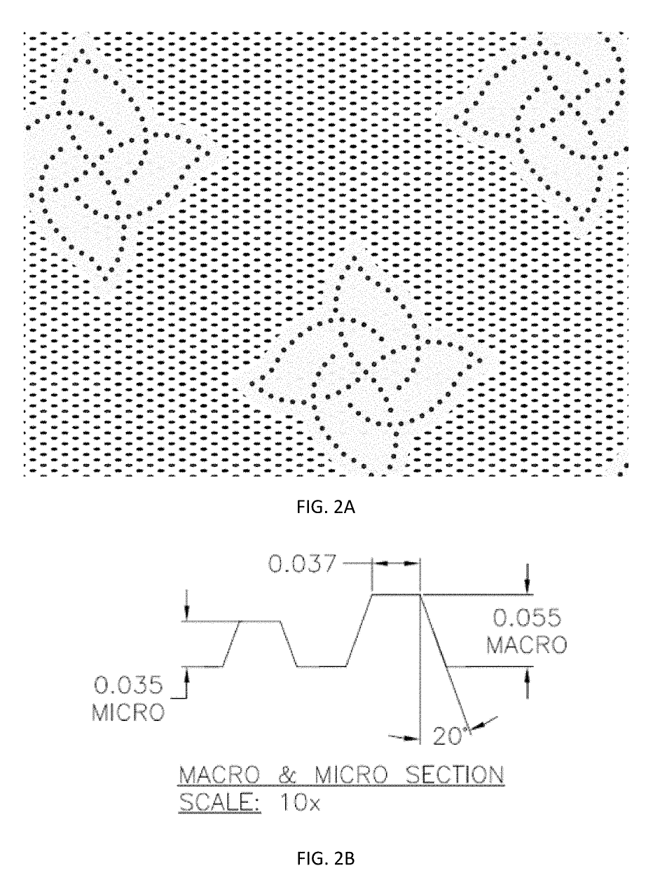

FIGS. 1A, 1B, 2A and 2B show emboss patterns according to exemplary embodiments of the present invention. The emboss pattern of FIG. 1A was made using an embossing roll with one set of embossing knobs forming a pinwheel pattern and another set of embossing knobs forming a wave pattern. As shown in FIG. 1B, the pinwheel pattern embossing knobs had an embossment depth of 0.55 thousands of an inch, and the wave pattern embossing knobs had an embossing depth of 0.25 thousands of an inch. The pinwheel pattern was embossed and laminated, while the wave pattern was embossed but not laminated. The emboss pattern of FIG. 2A was made using an embossing roll with one set of embossing knobs forming a pinwheel pattern and another set of embossing knobs forming a dotted pattern. As shown in FIG. 2B, the pinwheel pattern embossing knobs had an embossment depth of 0.55 thousands of an inch, and the wave pattern embossing knobs had an embossing depth of 0.35 thousands of an inch. The pinwheel pattern was embossed and laminated, while the dotted pattern was embossed but not laminated.

Softness Testing

Softness of a 2-ply tissue web was determined using a Tissue Softness Analyzer (TSA), available from EMTEC Electronic GmbH of Leipzig, Germany. The TSA comprises a rotor with vertical blades which rotate on the test piece to apply a defined contact pressure. Contact between the vertical blades and the test piece creates vibrations which are sensed by a vibration sensor. The sensor then transmits a signal to a PC for processing and display. The frequency analysis in the range of approximately 200 to 1000 Hz represents the surface smoothness or texture of the test piece and is referred to as the TS750 value. A further peak in the frequency range between 6 and 7 kHz represents the bulk softness of the test piece and is referred to as the TS7 value. Both TS7 and TS750 values are expressed as dB V² rms. The stiffness of the sample is also calculated as the device measures deformation of the sample under a defined load. The stiffness value (D) is expressed as mm/N. The device also calculates a Hand Feel (HF) number with the value corresponding to a softness as perceived when someone touches a tissue sample by hand (the higher the HF number, the higher the softness). The HF number is a combination of the TS750, TS7, and stiffness of the sample measured by the TSA and calculated using an algorithm which also requires the caliper and basis weight of the sample. Different algorithms can be selected for different facial, toilet, and towel paper products. Before testing, a calibration check should be performed using “TSA Leaflet Collection No. 9” available from EMTECH dated 2016 May 10. If the calibration check demonstrates a calibration is necessary, “TSA Leaflet Collection No. 10” is followed for the calibration procedure available from EMTECH dated 2015 Sep. 9.

A punch was used to cut out five 100 cm² round samples from the web. One of the samples was loaded into the TSA, clamped into place (outward facing or embossed ply facing upward), and the TPII algorithm was selected from the list of available softness testing algorithms displayed by the TSA. After inputting parameters for the sample (including caliper and basis weight), the TSA measurement program was run. The test process was repeated for the remaining samples and the results for all the samples were averaged and the average HF number recorded

### Ball Burst Testing

The Ball Burst of a 2-ply tissue web was determined using a Tissue Softness Analyzer (TSA), available from emtec Electronic GmbH of Leipzig, Germany using a ball burst head and holder. A punch was used to cut out five 100 cm² round samples from the web. One of the samples was loaded into the TSA, with the embossed surface facing down, over the holder and held into place using the ring. The ball burst algorithm was selected from the list of available softness testing algorithms displayed by the TSA. The ball burst head was then pushed by the TSA through the sample until the web ruptured and calculated the grams force required for the rupture to occur. The test process was repeated for the remaining samples and the results for all the samples were averaged.

Stretch & MD, CD, and Wet CD Tensile Strength Testing

An Instron 3343 tensile tester, manufactured by Instron of Norwood, Mass., with a 100N load cell and 25.4 mm rubber coated jaw faces was used for tensile strength measurement. Prior to measurement, the Instron 3343 tensile tester was calibrated. After calibration, 8 strips of 2-ply product, each 2.54 cm by 10.16 cm (one inch by four inches), were provided as samples for each test. When testing MD (Material Direction) tensile strength, the strips are cut in the MD direction. When testing CD (Cross Direction) tensile strength, the strips are cut in the CD direction. One of the sample strips was placed in between the upper jaw faces and clamp, and then between the lower jaw faces and clamp with a gap of 5.08 cm (2 inches) between the clamps. A test was run on the sample strip to obtain tensile strength and stretch. The test procedure was repeated until all the samples were tested. The values obtained for the eight sample strips were averaged to determine the tensile strength of the tissue. When testing CD wet tensile, the strips are placed in an oven at 105 degrees Celsius for 5 minutes and saturated with 75 microliters of deionized water immediately prior to pulling the sample.

Lint Testing

The amount of lint generated from a tissue product was determined with a Sutherland Rub Tester. This tester uses a motor to rub a weighted felt 5 times over the stationary tissue. The Hunter Color L value is measured before and after the rub test. The difference between these two Hunter Color L values is calculated as lint.

Lint Testing—Sample Preparation:

Prior to the lint rub testing, the paper samples to be tested should be conditioned according to Tappi Method #T402OM-88. Here, samples are preconditioned for 24 hours at a relative humidity level of 10 to 35% and within a temperature range of 22° to 40° C. After this preconditioning step, samples should be conditioned for 24 hours at a relative humidity of 48 to 52% and within a temperature range of 22° to 24° C. This rub testing should also take place within the confines of the constant temperature and humidity room.

The Sutherland Rub Tester may be obtained from Testing Machines, Inc. (Amityville, N.Y. 11701). The tissue is first prepared by removing and discarding any product which might have been abraded in handling, e.g. on the outside of the roll. For multi-ply finished product, three sections with each containing two sheets of multi-ply product are removed and set on the bench-top. For single-ply product, six sections with each containing two sheets of single-ply product are removed and set on the bench-top. Each sample is then folded in half such that the crease is running along the cross direction (CD) of the tissue sample. For the multi-ply product, make sure one of the sides facing out is the same side facing out after the sample is folded. In other words, do not tear the plies apart from one another and rub test the sides facing one another on the inside of the product. For the single-ply product, make up 3 samples with the off-Yankee side out and 3 with the Yankee side out. Keep track of which samples are Yankee side out and which are off-Yankee side out.

Obtain a 30″×40″ piece of Crescent #300 cardboard from Cordage Inc. (800 E. Ross Road, Cincinnati, Ohio, 45217). Using a paper cutter, cut out six pieces of cardboard of dimensions of 2.5″×6″. Puncture two holes into each of the six cards by forcing the cardboard onto the hold down pins of the Sutherland Rub tester.

If working with single-ply finished product, center and carefully place each of the 2.5″×6″ cardboard pieces on top of the six previously folded samples. Make sure the 6″ dimension of the cardboard is running parallel to the machine direction (MD) of each of the tissue samples. If working with multi-ply finished product, only three pieces of the 2.5″×6″ cardboard will be required. Center and carefully place each of the cardboard pieces on top of the three previously folded samples. Once again, make sure the 6″ dimension of the cardboard is running parallel to the machine direction (MD) of each of the tissue samples.

Fold one edge of the exposed portion of tissue sample onto the back of the cardboard. Secure this edge to the cardboard with adhesive tape obtained from 3M Inc. (¾″ wide Scotch Brand, St. Paul, Minn.). Carefully grasp the other over-hanging tissue edge and snugly fold it over onto the back of the cardboard. While maintaining a snug fit of the paper onto the board, tape this second edge to the back of the cardboard. Repeat this procedure for each sample.

Turn over each sample and tape the cross direction edge of the tissue paper to the cardboard. One half of the adhesive tape should contact the tissue paper while the other half is adhering to the cardboard. Repeat this procedure for each of the samples. If the tissue sample breaks, tears, or becomes frayed at any time during the course of this sample preparation procedure, discard and make up a new sample with a new tissue sample strip.

If working with multi-ply converted product, there will now be 3 samples on the cardboard. For single-ply finished product, there will now be 3 off-Yankee side out samples on cardboard and 3 Yankee side out samples on cardboard.

Lint Testing—Felt Preparation

Obtain a 30″×40″ piece of Crescent #300 cardboard from Cordage Inc. (800 E. Ross Road, Cincinnati, Ohio, 45217). Using a paper cutter, cut out six pieces of cardboard of dimensions of 2.25″×7.25″. Draw two lines parallel to the short dimension and down 1.125″ from the top and bottom most edges on the white side of the cardboard. Carefully score the length of the line with a razor blade using a straight edge as a guide. Score it to a depth about half way through the thickness of the sheet. This scoring allows the cardboard/felt combination to fit tightly around the weight of the Sutherland Rub tester. Draw an arrow running parallel to the long dimension of the cardboard on this scored side of the cardboard.

Cut the six pieces of black felt (F-55 or equivalent from New England Gasket, 550 Broad Street, Bristol, Conn. 06010) to the dimensions of 2.25″×8.5″×0.0625. Place the felt on top of the unscored, green side of the cardboard such that the long edges of both the felt and cardboard are parallel and in alignment. Make sure the fluffy side of the felt is facing up. Also allow about 0.5″ to overhang the top and bottom most edges of the cardboard. Snuggly fold over both overhanging felt edges onto the backside of the cardboard with Scotch brand tape. Prepare a total of six of these felt/cardboard combinations.

For best reproducibility, all samples should be run with the same lot of felt. Obviously, there are occasions where a single lot of felt becomes completely depleted. In those cases where a new lot of felt must be obtained, a correction factor should be determined for the new lot of felt. To determine the correction factor, obtain a representative single tissue sample of interest, and enough felt to make up 24 cardboard/felt samples for the new and old lots.

As described below and before any rubbing has taken place, obtain Hunter L readings for each of the 24 cardboard/felt samples of the new and old lots of felt. Calculate the averages for both the 24 cardboard/felt samples of the old lot and the 24 cardboard/felt samples of the new lot.

Next, rub test the 24 cardboard/felt boards of the new lot and the 24 cardboard/felt boards of the old lot as described below. Make sure the same tissue lot number is used for each of the 24 samples for the old and new lots. In addition, sampling of the paper in the preparation of the cardboard/tissue samples must be done so the new lot of felt and the old lot of felt are exposed to as representative as possible of a tissue sample. For the case of 1-ply tissue product, discard any product which might have been damaged or abraded. Next, obtain 48 strips of tissue each two usable units (also termed sheets) long. Place the first two usable unit strip on the far left of the lab bench and the last of the 48 samples on the far right of the bench. Mark the sample to the far left with the number “1” in a 1 cm by 1 cm area of the corner of the sample. Continue to mark the samples consecutively up to 48 such that the last sample to the far right is numbered 48.

Use the 24 odd numbered samples for the new felt and the 24 even numbered samples for the old felt. Order the odd number samples from lowest to highest. Order the even numbered samples from lowest to highest. Now, mark the lowest number for each set with a letter “Y.” Mark the next highest number with the letter “O.” Continue marking the samples in this alternating “Y”/“O” pattern. Use the “Y” samples for yankee side out lint analyses and the “O” samples for off-Yankee side lint analyses. For 1-ply product, there are now a total of 24 samples for the new lot of felt and the old lot of felt. Of this 24, twelve are for yankee side out lint analysis and 12 are for off-yankee side lint analysis.

Rub and measure the Hunter Color L values for all 24 samples of the old felt as described below. Record the 12 yankee side Hunter Color L values for the old felt. Average the 12 values. Record the 12 off-yankee side Hunter Color L values for the old felt. Average the 12 values. Subtract the average initial un-rubbed Hunter Color L felt reading from the average Hunter Color L reading for the yankee side rubbed samples. This is the delta average difference for the yankee side samples. Subtract the average initial un-rubbed Hunter Color L felt reading from the average Hunter Color L reading for the off-yankee side rubbed samples. This is the delta average difference for the off-yankee side samples. Calculate the sum of the delta average difference for the yankee-side and the delta average difference for the off-yankee side and divide this sum by 2. This is the uncorrected lint value for the old felt. If there is a current felt correction factor for the old felt, add it to the uncorrected lint value for the old felt. This value is the corrected Lint Value for the old felt.

Rub and measure the Hunter Color L values for all 24 samples of the new felt as described below. Record the 12 yankee side Hunter Color L values for the new felt. Average the 12 values. Record the 12 off-yankee side Hunter Color L values for the new felt. Average the 12 values. Subtract the average initial un-rubbed Hunter Color L felt reading from the average Hunter Color L reading for the yankee side rubbed samples. This is the delta average difference for the yankee side samples. Subtract the average initial un-rubbed Hunter Color L felt reading from the average Hunter Color L reading for the off-yankee side rubbed samples. This is the delta average difference for the off-yankee side samples. Calculate the sum of the delta average difference for the yankee-side and the delta average difference for the off-yankee side and divide this sum by 2. This is the uncorrected lint value for the new felt.

Take the difference between the corrected Lint Value from the old felt and the uncorrected lint value for the new felt. This difference is the felt correction factor for the new lot of felt.

Adding this felt correction factor to the uncorrected lint value for the new felt should be identical to the corrected Lint Value for the old felt.

The same type procedure is applied to two-ply tissue product with 24 samples run for the old felt and 24 run for the new felt. But, only the consumer used outside layers of the plies are rub tested. As noted above, make sure the samples are prepared such that a representative sample is obtained for the old and new felts.

Lint Testing—Care of 4 Pound Weight

The four pound weight has four square inches of effective contact area providing a contact pressure of one pound per square inch. Since the contact pressure can be changed by alteration of the rubber pads mounted on the face of the weight, it is important to use only the rubber pads supplied by the manufacturer (Brown Inc., Mechanical Services Department, Kalamazoo, Mich.). These pads must be replaced if they become hard, abraded or chipped off.

When not in use, the weight must be positioned such that the pads are not supporting the full weight of the weight. It is best to store the weight on its side.

Lint Testing—Rub Tester Instrument Calibration

The Sutherland Rub Tester must first be calibrated prior to use. First, turn on the Sutherland Rub Tester by moving the tester switch to the “cont” position. When the tester arm is in its position closest to the user, turn the tester's switch to the “auto” position. Set the tester to run 5 strokes by moving the pointer arm on the large dial to the “five” position setting. One stroke is a single and complete forward and reverse motion of the weight. The end of the rubbing block should be in the position closest to the operator at the beginning and at the end of each test.

Prepare a tissue paper on cardboard sample as described above. In addition, prepare a felt on cardboard sample as described above. Both of these samples will be used for calibration of the instrument and will not be used in the acquisition of data for the actual samples.

Place this calibration tissue sample on the base plate of the tester by slipping the holes in the board over the hold-down pins. The hold-down pins prevent the sample from moving during the test. Clip the calibration felt/cardboard sample onto the four pound weight with the cardboard side contacting the pads of the weight. Make sure the cardboard/felt combination is resting flat against the weight. Hook this weight onto the tester arm and gently place the tissue sample underneath the weight/felt combination. The end of the weight closest to the operator must be over the cardboard of the tissue sample and not the tissue sample itself. The felt must rest flat on the tissue sample and must be in 100% contact with the tissue surface. Activate the tester by depressing the “push” button.

Keep a count of the number of strokes and observe and make a mental note of the starting and stopping position of the felt covered weight in relationship to the sample. If the total number of strokes is five and if the end of the felt covered weight closest to the operator is over the cardboard of the tissue sample at the beginning and end of this test, the tester is calibrated and ready to use. If the total number of strokes is not five or if the end of the felt covered weight closest to the operator is over the actual paper tissue sample either at the beginning or end of the test, repeat this calibration procedure until 5 strokes are counted the end of the felt covered weight closest to the operator is situated over the cardboard at the both the start and end of the test.

During the actual testing of samples, monitor and observe the stroke count and the starting and stopping point of the felt covered weight. Recalibrate when necessary.

Lint Testing—Hunter Color Meter Calibration

Adjust the Hunter Color Difference Meter for the black and white standard plates according to the procedures outlined in the operation manual of the instrument. Also run the stability check for standardization as well as the daily color stability check if this has not been done during the past eight hours. In addition, the zero reflectance must be checked and readjusted if necessary.

Place the white standard plate on the sample stage under the instrument port. Release the sample stage and allow the sample plate to be raised beneath the sample port.

Using the “L-Y”, “a-X”, and “b-Z” standardizing knobs, adjust the instrument to read the Standard White Plate Values of “L”, “a”, and “b” when the “L”, “a”, and “b” push buttons are depressed in turn.

Lint Testing—Measurement of Samples

The first step in the measurement of lint is to measure the Hunter color values of the black felt/cardboard samples prior to being rubbed on the tissue. The first step in this measurement is to lower the standard white plate from under the instrument port of the Hunter color instrument. Center a felt covered cardboard, with the arrow pointing to the back of the color meter, on top of the standard plate. Release the sample stage, allowing the felt covered cardboard to be raised under the sample port.

Since the felt width is only slightly larger than the viewing area diameter, make sure the felt completely covers the viewing area. After confirming complete coverage, depress the L push button and wait for the reading to stabilize. Read and record this L value to the nearest 0.1 unit.

If a D25D2A head is in use, lower the felt covered cardboard and plate, rotate the felt covered cardboard 90 degrees so the arrow points to the right side of the meter. Next, release the sample stage and check once more to make sure the viewing area is completely covered with felt. Depress the L push button. Read and record this value to the nearest 0.1 unit. For the D25D2M unit, the recorded value is the Hunter Color L value. For the D25D2A head where a rotated sample reading is also recorded, the Hunter Color L value is the average of the two recorded values.

Measure the Hunter Color L values for all of the felt covered cardboards using this technique. If the Hunter Color L values are all within 0.3 units of one another, take the average to obtain the initial L reading. If the Hunter Color L values are not within the 0.3 units, discard those felt/cardboard combinations outside the limit. Prepare new samples and repeat the Hunter Color L measurement until all samples are within 0.3 units of one another.

For the measurement of the actual tissue paper/cardboard combinations, place the tissue sample/cardboard combination on the base plate of the tester by slipping the holes in the board over the hold-down pins. The hold-down pins prevent the sample from moving during the test. Clip the calibration felt/cardboard sample onto the four pound weight with the cardboard side contacting the pads of the weight. Make sure the cardboard/felt combination is resting flat against the weight. Hook this weight onto the tester arm and gently place the tissue sample underneath the weight/felt combination. The end of the weight closest to the operator must be over the cardboard of the tissue sample and not the tissue sample itself. The felt must rest flat on the tissue sample and must be in 100% contact with the tissue surface.

Next, activate the tester by depressing the “push” button. At the end of the five strokes the tester will automatically stop. Note the stopping position of the felt covered weight in relation to the sample. If the end of the felt covered weight toward the operator is over cardboard, the tester is operating properly. If the end of the felt covered weight toward the operator is over sample, disregard this measurement and recalibrate as directed above in the Sutherland Rub Tester Calibration section.

Remove the weight with the felt covered cardboard. Inspect the tissue sample. If torn, discard the felt and tissue and start over. If the tissue sample is intact, remove the felt covered cardboard from the weight. Determine the Hunter Color L value on the felt covered cardboard as described above for the blank felts. Record the Hunter Color L readings for the felt after rubbing. Rub, measure, and record the Hunter Color L values for all remaining samples.

After all tissues have been measured, remove and discard all felt. Felts strips are not used again. Cardboards are used until they are bent, torn, limp, or no longer have a smooth surface.

Lint Testing—Calculations

Determine the delta L values by subtracting the average initial L reading found for the unused felts from each of the measured values for the off-Yankee and Yankee sides of the sample. Recall, multi-ply-ply product will only rub one side of the paper. Thus, three delta L values will be obtained for the multi-ply product. Average the three delta L values and subtract the felt factor from this final average. This final result is termed the lint for the fabric side of the 2-ply product.

For the single-ply product where both Yankee side and off-Yankee side measurements are obtained, subtract the average initial L reading found for the unused felts from each of the three Yankee side L readings and each of the three off-Yankee side L readings. Calculate the average delta for the three Yankee side values. Calculate the average delta for the three fabric side values. Subtract the felt factor from each of these averages. The final results are termed a lint for the fabric side and a lint for the Yankee side of the single-ply product. By taking the average of these two values, an ultimate lint value is obtained for the entire single-ply product.

Basis Weight

Using a dye and press, six 76.2 mm by 76.2 mm square samples were cut from a 2-ply product being careful to avoid any web perforations. The samples were placed in an oven at 105 deg C. for 5 minutes before being weighed on an analytical balance to the fourth decimal point. The weight of the sample in grams was divided by (0.0762 m)² to determine the basis weight in grams/m².

Caliper Testing

A Thwing-Albert ProGage 100 Thickness Tester, manufactured by Thwing Albert of West Berlin, N.J. was used for the caliper test. Eight 100 mm×100 mm square samples were cut from a 2-ply product. The samples were then tested individually and the results were averaged to obtain a caliper result for the base sheet.

The following Examples illustrate various features and advantages of the present invention:

### Example 1: 2-Ply Laminate Tissue with Only Laminated Embossments

A rolled 2-ply sanitary tissue product with 176 sheets, a roll diameter of 116 mm, with sheets a length of 4.0 inches and width of 4.0 inches, was produced by laminating two webs of through air dried tissue using the nested emboss process shown in FIG. 3 modified so that the embossing roll 204 contained a pinwheel pattern with 2.2% coverage area and the emboss roll 206 was non-patterned. The 2-ply tissue product further had the following product attributes: Basis Weight 38.7 g/m², Caliper 0.535 mm, MD tensile of 165 N/m, CD tensile of 92 N/m, a ball burst of 290 grams force, a lint value of 4.93, an MD stretch of 16.7%, a CD stretch of 7.7%, and a CD wet tensile of 11.2 N/m., and a 88.5 HF.

The tissue web was multilayered with the fiber and chemistry of each layer selected and prepared individually to maximize product quality attributes of softness and strength. The first exterior layer, which was the layer that contacted the Yankee dryer, was prepared using 80% eucalyptus with 0.25 kg/ton of the amphoteric starch Redibond 2038 (Corn Products, 10 Finderne Avenue, Bridgewater, N.J. 08807) (for lint control) and 0.25 kg/ton of the glyoxylated polyacrylamide Hercobond 1194 (Ashland, 500 Hercules Road, Wilmington Del., 19808) (for strength when wet and lint control). The interior layer was composed of 40% northern bleached softwood kraft fibers, 60% eucalyptus fibers, and 1.0 kg/ton of T526 a softener/debonder (EKA Chemicals Inc., 1775 West Oak Commons Court, Marietta, Ga., 30062). The second exterior layer was composed of 20% northern bleached softwood kraft fibers, 80% eucalyptus fibers and 3.0 kg/ton of Redibond 2038 (to limit refining and impart Z-direction strength). Softwood was refined at 115 kwh/ton to impart the necessary tensile strength.

The fiber and chemical mixtures were diluted to a solids of 0.5% consistency and fed to separate fan pumps which delivered the slurry to a triple layered headbox. The headbox pH was controlled to 7.0 by addition of a caustic to the thick stock before the fan pumps. The headbox deposited the slurry to a nip formed by a forming roll, an outer forming wire, and inner forming wire. The slurry was drained through the outer wire, which was a KT194-P design supplied by Asten Johnson (4399 Corporate Rd, Charleston, S.C. (843) 747-7800)), to aid with drainage, fiber support, and web formation. When the fabrics separated, the web followed the inner forming wire and was dried to approximately 25% solids using a series of vacuum boxes and a steam box.

The web was then transferred to a structured fabric with the aid of a vacuum box to facilitate fiber penetration into the structured fabric to enhance bulk softness and web imprinting. The structured fabric was a Prolux 005 design supplied by Albany (216 Airport Drive Rochester, N.H. 03867 USA) and was a 5 shed design with a warp pick sequence of 1, 3, 5, 2, 4, a 17.8 by 11.1 yarn/cm Mesh and Count, a 0.35 mm warp monofilament, a 0.50 mm weft monofilament, a 1.02 mm caliper, with a 640 cfm and a knuckle surface that was sanded to impart 27% contact area with the Yankee dryer. The web was dried with the aid of two TAD hot air impingement drums to 85% moisture before transfer to the Yankee dryer.

The web was held in intimate contact with the Yankee surface using an adhesive coating chemistry. The Yankee was provided steam at 3.0 bar while the installed hot air impingement hood over the Yankee blew heated air up to 450 deg C. The web was creped from the Yankee at 10% crepe using a ceramic blade at a pocket angle of 90 degrees. The caliper of the web was approximately 375 microns (single ply) before traveling through the calender to reduce the bulk to 275 microns (single ply). The web was cut into two of equal width using a high pressure water stream at 10,000 psi and reeled into two equally sized parent rolls and transported to the converting process.

In the converting process, the two webs were plied together using embossing where only the top web was embossed by a steel roll (FIG. 3, reference number 204) and laminated to the bottom web with an adhesive applied to the inside of the top web at the high points derived from the embossments. The adhesive was comprised of 3.5% solids polyvinyl alcohol heated to 120 deg F. The steel roll (FIG. 3, reference number 204) had a pinwheel pattern with embossments of 0.55 thousands of an inch in depth and a total top sheet coverage area of 2.2%. The emboss nip width between the steel roll (FIG. 3, reference number 204) and rubber covered pressure roll (FIG. 3, reference number 203) was measured at 30 mm. The product was wound into a 176 sheet count product at 116 mm roll diameter.

### Example 2: 2-Ply Laminate Tissue with Laminated Embossed Areas and Low Coverage Non Laminated Embossed Areas

A rolled 2-ply sanitary tissue product with 176 sheets, a roll diameter of 116 mm, with sheets a length of 4.0 inches and width of 4.0 inches, was produced by laminating two webs of through air dried tissue using the nested emboss process shown in FIG. 3. The 2-ply tissue product further had the following product attributes: Basis Weight 38.5 g/m², Caliper 0.572 mm, MD tensile of 152 N/m, CD tensile of 85 N/m, a ball burst of 267 grams force, a lint value of 6.0, an MD stretch of 17.2%, a CD stretch of 9.2%, and a CD wet tensile of 9.7 N/m., and a 92 HF.

The tissue web used in this Example was the same as described in Example 1. The web was cut into two of equal width using a high pressure water stream at 10,000 psi and reeled into two equally sized parent rolls and transported to the converting process.

In the converting process, the two webs were plied together using the embossing process shown in FIG. 3 where only the top sheet was embossed by a steel roll (FIG. 3, reference number 204) and laminated to the bottom web with an adhesive applied to the inside of the top sheet at the high points derived from the embossments using an adhesive comprised of 3.5% solids polyvinyl alcohol heated to 120 deg F. The steel roll (FIG. 3, reference number 204) had a pinwheel pattern with embossments of 0.055 inch in depth and a total top sheet coverage area of 2.2%. This same steel roll also had embossments at 0.025 inch in depth with a total top sheet coverage of 7.8% (embossment pattern shown in FIG. 1.). The emboss nip width between the steel roll (FIG. 3, reference number 204) and rubber covered pressure roll (FIG. 3, reference number 203) was measured at 30 mm. Steel roll (FIG. 3, reference number 206) was a non patterned roll. The product was wound into a 176 sheet count product at 116 mm roll diameter.

### Example 3: 2-Ply Laminate Tissue with Laminated Embossed Areas and High Coverage Non Laminated Embossed Areas

A rolled 2-ply sanitary tissue product with 176 sheets, a roll diameter of 116 mm, with sheets a length of 4.0 inches and width of 4.0 inches, was produced by laminating two webs of through air dried tissue using the nested emboss process shown in FIG. 3. The 2-ply tissue product further had the following product attributes: Basis Weight 38.5 g/m², Caliper 0.560 mm, MD tensile of 149 N/m, CD tensile of 85 N/m, a ball burst of 260 grams force, a lint value of 4.92, an MD stretch of 16.5%, a CD stretch of 9.6%, and a CD wet tensile of 9.2 N/m., and a 91.9 HF.

The tissue web used in this Example was the same as described in Example 1. The web was cut into two of equal width using a high pressure water stream at 10,000 psi and reeled into two equally sized parent rolls and transported to the converting process.

In the converting process, the two webs were plied together using embossing where only the top sheet was embossed by a steel roll (FIG. 3, reference number 204) and laminated to the bottom web with an adhesive applied to the inside of the top sheet at the high points derived from the embossments using an adhesive comprised of 3.5% solids polyvinyl alcohol heated to 120 deg F. The steel roll (FIG. 3, reference number 204) had a pinwheel pattern with embossments of 0.055 inch in depth and a total top sheet coverage area of 2.2%. This same steel roll also had embossments at 0.035 inch in depth with a total top sheet coverage of 16% (embossment pattern shown in FIG. 2). The emboss nip width between the steel roll (FIG. 3, reference number 204) and rubber covered pressure roll (FIG. 3, reference number 203) was measured at 33 mm. Steel roll (FIG. 3, reference number 206) was a non patterned roll. The product was wound into a 176 sheet count product at 116 mm roll diameter.

Table 1 provides a summary of the data pertaining to Examples 1-3.

TABLE 1

| | EXAMPLE 1 | EXAMPLE 2 | EXAMPLE 3 |
|---|---|---|---|
| BASIS WEIGHT | 38.7 | 38.5 | 38.5 |
| (g/m²) | | | |
| CALIPER | 0.535 | 0.572 | 0.560 |
| (mm) | | | |
| MD TENSILE | 165 | 152 | 149 |
| STRENGTH | | | |
| (N/m) | | | |
| CD TENSILE | 92 | 85 | 85 |
| STRENGTH | | | |
| (N/m) | | | |
| BALL BURST | 290 | 267 | 260 |
| (grams force) | | | |
| LINT VALUE | 4.93 | 6.0 | 4.92 |
| MD STRETCH | 16.7 | 17.2 | 16.5 |
| (%) | | | |
| CD STRETCH | 7.7 | 9.2 | 9.6 |
| (%) | | | |
| CD WET TENSILE | 11.2 | 9.7 | 9.2 |
| STRENGTH | | | |
| (N/m) | | | |
| SOFTNESS | 88.5 | 92 | 91.9 |
| (HF) | | | |
| T57 | 9.79 | 8.84 | 8.81 |

As shown in Table 1, the use of embossments with varying depths on the steel roll during the converting process (Examples 2 and 3) results in a tissue laminate with enhanced flexibility and softness. In particular, Example 1, which did not use a varying depth embossment steel roll, did not exhibit the same relatively high level of softness (HF) and CD stretch as compared to Examples 2 and 3.

Now that embodiments of the present invention have been shown and described in detail, various modifications and improvements thereon will become readily apparent to those skilled in the art. Accordingly, the spirit and scope of the present invention is to be construed broadly and not limited by the foregoing specification.

What is claimed is:

1. A structured, multi-layer tissue comprising a first ply and a second ply, at least the first ply comprising first embossed areas and second embossed areas, the first embossed areas being laminated with the second ply and the second embossed areas not being laminated with the second ply.

2. The structured, multilayer tissue of claim 1, wherein the first embossed areas are laminated by adhesive.

3. The structured, multilayer tissue of claim 1, wherein the second embossed areas are devoid of adhesive.

4. The structured, multilayer tissue of claim 1, wherein the tissue has a softness of at least 90 HF.

5. The structured, multilayer tissue of claim 1, wherein the tissue has a TS7 less than 10.

6. The structured, multilayer tissue of claim 1, wherein the tissue has a CD stretch of at least 9.0%.

7. The structured, multilayer tissue of claim 1, wherein the tissue has a ball burst of less than 270 grams force.

8. The structured, multilayer tissue of claim 1, wherein the tissue is a through air dried tissue.

9. The structured, multilayer tissue of claim 1, wherein the tissue is made by an NTT process.

10. The structured, multilayer tissue of claim 1, wherein the second ply comprises first embossed areas and second embossed areas, the first embossed areas of the second ply are laminated with the first embossed areas of the first ply and the second embossed areas of the second ply are not laminated with the second embossed areas of the first ply.

11. A through-air-dried, multi-layer tissue comprising a first ply and a second ply, at least the first ply comprising first embossed areas and second embossed areas, the first embossed areas being laminated with the second ply and the second embossed areas not being laminated with the second ply.

12. The through-air-dried, multilayer tissue of claim 11, wherein the first embossed areas are laminated by adhesive.

13. The through-air-dried, multilayer tissue of claim 11, wherein the second embossed areas are devoid of adhesive.

14. The through-air-dried, multilayer tissue of claim 11, wherein the tissue has a softness of at least 90 HF.

15. The through-air-dried, multilayer tissue of claim 11, wherein the tissue has a TS7 less than 10.

16. The through-air-dried, multilayer tissue of claim 11, wherein the tissue has a CD stretch of at least 9.0%.

17. The through-air-dried, multilayer tissue of claim 11, wherein the tissue has a ball burst of less than 270 grams force.

18. The through-air-dried, multilayer tissue of claim 11, wherein the second ply comprises first embossed areas and second embossed areas, the first embossed areas of the second ply are laminated with the first embossed areas of the first ply and the second embossed areas of the second ply are not laminated with the second embossed areas of the first ply.

19. A method of forming a structured, multilayer tissue comprising:
providing at least two plies of tissue web;
embossing at least one of the two plies using an embossment roll, the embossment roll comprising a pattern made up of first embossments of a first depth and second embossments of a second depth, the first depth being greater than the second depth, so that the at least one of the two plies comprises first embossed areas formed by the first embossments and second embossed areas formed by the second embossments;
applying adhesive to the embossed at least one of the two plies using an applicator roll so that the first embossed areas are coated with adhesive and the second embossed areas are left devoid of adhesive; and
laminating the at least two plies using the adhesive so that the at least one ply is laminated to the other ply only at the first embossed areas.

20. The method of claim 19, further comprising separately embossing the other ply.

21. The method of claim 19, wherein the two plies are formed by a through-air-dried process.

22. The method of claim 19, wherein the method results in a loss of machine direction tensile strength by an amount greater than 7% as compared to a multilayer tissue with all embossed areas laminated.

23. The method of claim 19, wherein the method results in a loss of machine direction tensile strength by an amount greater than 10% as compared to a multilayer tissue with all embossed areas laminated.

24. The method of claim 19, wherein the method results in a loss of machine direction tensile strength by an amount greater than 15% as compared to a multilayer tissue with all embossed areas laminated.

25. A structured, multi-layer tissue comprising a first ply and a second ply, at least the first ply comprising first embossed areas and second embossed areas, the first embossed areas being laminated with the second ply and the second embossed areas not being laminated with the second ply, the structured, multi-layer tissue having a TS7 less than 10 and a ball burst of greater than 200 grams force.
